(19) United States
(12) Patent Application Publication
(10) Pub. No.: US 2020/0288696 A1
(43) Pub. Date: Sep. 17, 2020

(54) Rodent Trap

(71) Applicant: David Cassens, Michael, IL (US)

(72) Inventor: David Cassens, Michael, IL (US)

(21) Appl. No.: 16/801,366

(22) Filed: Feb. 26, 2020

Related U.S. Application Data
(60) Provisional application No. 62/817,603, filed on Mar. 13, 2019.

(51) Int. Cl. A01M 23/08

(52) U.S. Cl. CPC A01M 23/08; A01K 5/01; A01M 2200/00

(57) ABSTRACT

An improved rodent trap is provided for enticing and entrapping rodents in a humane fashion, and that permits the entrapped rodents to survive within the trap until they can be released into a suitable environment. The improved rodent trap is preferably comprised of a transparent or translucent enclosure having a removable lid, a one way, spring biased door, an air supply, and a food and water source contained therein to sustain the rodents during their period of captivity. The removable lid is preferably attached to the enclosure via a “F” shaped channel that is positioned on each of a front panel and opposing side panels.

### CROSS-REFERENCE TO RELATEDAPPLICATION

The present application claims priority to and the benefit of U.S. Provisional Application No. 62/817,603 filed on Mar. 13, 2019, which is incorporated herein by reference in its entirety.

### BACKGROUND

The present invention relates generally to a new and improved rodent trap designed specifically to entice and entrap rodents in a humane fashion, and that permits the entrapped rodents to survive in the improved trap device until they can be released into a suitable environment. More specifically, the invention relates to an improved rodent trap having a food and water source securely contained therein to sustain the rodents during their period of captivity. Accordingly, the present specification makes specific reference thereto. However, it is to be appreciated that certain aspects of the present invention are also equally amenable to other like applications, devices and methods of manufacture.

Rodent traps are well known for catching, killing and/or maiming rodents such as mice, rats, chipmunks and the like. However, many homeowners and other users are opposed to killing or maiming rodents, and instead prefer to release the same back into the wild. Other rodent traps are known for catching rodents for subsequent release into the wild. However, both of the forgoing types of rodent traps typically include a plurality of movable parts that cause the rodent trap to break down or malfunction over time. Additionally, many rodent traps are incapable of keeping the rodent alive long enough, or healthy enough, to release the rodent into the wild. In particular, bait placed within known rodent traps may not be sufficient to keep the captured rodents alive for several days, or until the user can return to the rodent trap to release the captured rodents. Additionally, when extra rodent bait is placed within a known trap, the bait is often scattered throughout the trap or even blown from the rodent trap in windy conditions. As such, the rodent bait is not always effective in attracting and/or enticing the rodents into the trap, and the rodent bait is oftentimes not sufficient to maintain the life or health of the captured rodent over several days.

Additionally, peanut butter is oftentimes used to bait a rodent trap, such as a mouse trap. However, for the live catch and release of rodents such as mice, peanut butter without water actually dehydrates and kills mice. Therefore, a different form of bait and water system is needed to sustain a rodent such as a mouse for several days until the user can return to the trap and release the captured rodents. While some rodent traps have interior surfaces where a cup or container of water can rest, a frantic, trapped rodent will oftentimes tip or spill the water container and subsequently not have water to drink.

Another drawback of prior art rodent traps is that the entrapped rodent may be capable of escaping the trap. For example, if a movable part in the trap malfunctions when the rodent is caught, the rodent may be able to easily escape the trap. Moreover, some rodents are capable of jumping to such heights that the rodent may be able to climb out of the trap if the trap walls are not sufficiently high or if the rodent trap is not completely enclosed. Additionally, many existing wire mesh rodent traps allow the rodent to climb out of the trap, or chew through a surface of the trap and escape.

Still other prior art rodent traps are opaque in nature and do not permit a user to see into the trap to determine if it contains a rodent or rodents without opening the trap device, which could lead to the unintentional release of the rodent(s) back into the very location in which they were initially trapped or captured.

Consequently, there exists a long felt need in the art for an improved rodent trap that overcomes the above referenced limitations of existing rodent traps. More specifically, there is a long felt need in the art for an improved rodent trap that enables the captured rodent to survive for a prolonged period of time until it can be released by the user to an appropriate location. There is also a long felt need in the art for an improved rodent trap that minimizes the possibility that the rodent will be able to escape the trap after being caught, and that enables the user to efficiently determine if a rodent is present in the trap without having to open the same. Finally, there is a long felt need in the art for an improved rodent trap that is resistant to being chewed through, that is relatively inexpensive to manufacture, and that is safe and easy to use and does not present an unwanted danger to small children and/or pets. The present invention discloses an improved rodent trap comprised of a transparent or translucent material to enable a user to view into the trap without opening the same, and having an enclosure with a removable lid and a food and water source securely located within the trap enclosure.

The present invention, in one exemplary embodiment, discloses an improved rodent trap that comprises an enclosure, a removable lid assembly for use with the enclosure, a tunnel, and a trap door mechanism to permit rodents, such as mice, rats, chipmunks and the like to enter into, but not exit, the enclosure via the tunnel. The enclosure of the improved rodent trap further comprises a food tray and a water basin, both of which are secured to a base of the enclosure in a spaced apart fashion, and one or more handles for securely handling and transporting the improved rodent trap of the present invention to, for example, an appropriate location to release the captured rodent into the wild.

In this manner, the improved rodent trap of the present invention accomplishes all of the forgoing objectives, thereby improving the ability of a user to successfully sustain the life of a captured rodent during its period of captivity, and subsequently relocate and release the captured rodent at an appropriate time and location. The improved rodent trap of the present invention also allows a user to easily determine if the trap contains captured rodents without having to open the trap, which could lead to the premature release of the captured rodent.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an improved rodent trap device for enticing, capturing and prolonging the life and well-being of the captured rodent(s) until such time as they can be relocated and released into a proper environment. More specifically, the improved rodent trap preferably comprises an enclosure, a corresponding and removable lid to said enclosure, a tunnel, a trap door mechanism, a food tray and a water basin.

The enclosure is preferably comprised of a base or bottom, a front panel, a back panel, opposing side panels connecting said front panel to said back panel and defining an interior space. The top portions of said opposing side panels preferably have an “F” shaped groove or channel extending outwardly therefrom in the direction of the interior space for sliding receipt of the removable lid portion, and a plurality or continuous openings therein to permit air to flow in and out of the enclosure when the removable lid is secured thereto to permit the rodents to receive oxygen. The tunnel extends through an opening in the front panel of the enclosure and permits rodents to access the interior space of the enclosure. Further, the one way trap door mechanism positioned part way along the length of the tunnel permits the rodents to enter, but not leave the enclosure of the improved rodent trap one they have entered the same.

Additionally, the water basin and food tray of the improved rodent trap of the present invention, in one exemplary embodiment, are fixedly secured to the base of the enclosure in spaced apart fashion to prohibit the commingling and spillage of the same. The presence of the food and/or water not only entices the rodents to enter into the improved rodent trap of the present invention through the tunnel and trap door mechanism, but also allows the rodents to exist within the enclosure in a humane fashion and for a prolonged period of time until they can be released into an appropriate environment. Further, the presence of the removable lid permits a user to quickly and easily service the food tray and/or water basin with minimal effort.

In a further embodiment of the improved rodent trap of the present invention, the entire trap is comprised of a generally transparent or translucent material so that a user can easily determine if there are any rodents within the improved rodent trap without having to remove the lid to determine the same, which could lead to the premature and unintentional released of the captured rodents. In other embodiments, only the removable lid is comprised of a generally transparent or translucent material.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of one possible embodiment of the improved rodent trap of the present invention with the lid portion removed, and in accordance with the disclosed architecture.

FIG. 2 illustrates a top perspective view of the improved rodent trap of FIG. 1 with the lid portion removed in spaced apart fashion and in accordance with the disclosed architecture.

FIG. 3 illustrates a side elevational view of the improved rodent trap of FIG. 1 at cut line 3-3 and with the lid portion removed in spaced apart fashion in accordance with the disclosed architecture.

FIG. 4 illustrates a sectional view of the improved rodent trap of FIG. 1 at cut-line 4-4 and with the lid portion removably secured thereto in accordance with the disclosed architecture.

FIG. 5 illustrates a front partial view of the “F” channel positioned near the top of a sidewall of the improved rodent trap of FIG. 1 with a portion of the removable lid positioned therein in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, there exists in the art a long felt need for an improved rodent trap that overcomes the above referenced limitations of existing rodent traps, and that enables a captured rodent to survive within the improved rodent trap for a prolonged period of time and until it can be released by the user to an appropriate location. There is also a long felt need in the art for an improved rodent trap that minimizes the possibility that the rodent will be able to escape the trap after being caught, and that enables the user to efficiently determine if a rodent is present in the trap without having to open the same. Finally, there is a long felt need in the art for an improved rodent trap that is resistant to being chewed through, that is relatively inexpensive to manufacture, and that is safe and easy to use and does not present an unwanted danger to small children and/or pets.

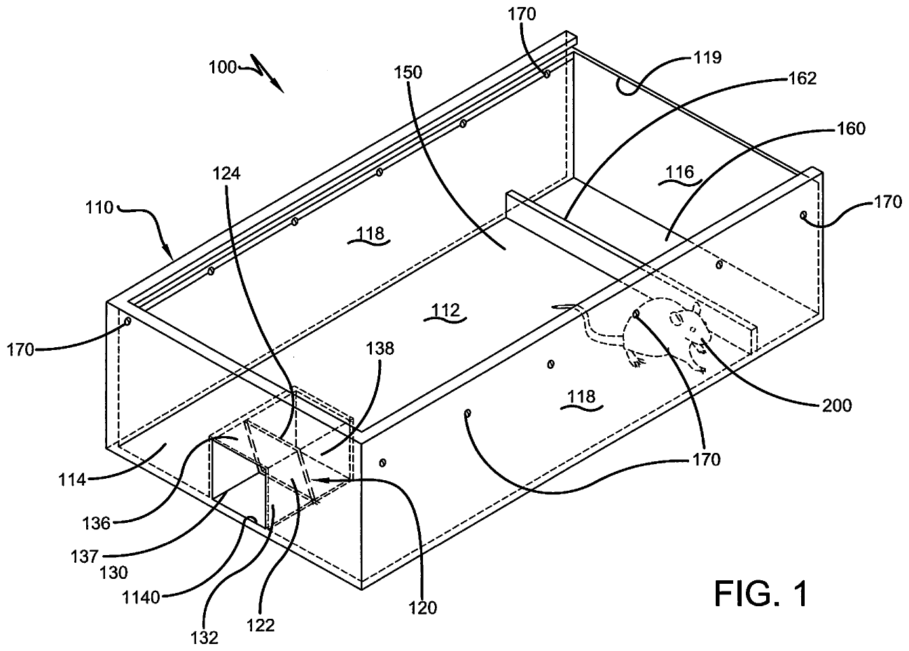

Referring initially to the drawings, FIG. 1 illustrates a perspective view of one potential embodiment of the improved rodent trap 100 of the present invention and having an enclosure portion 110, a trap door mechanism 120, a tunnel portion 130, a removable lid portion 140, a food tray 150 and a water basin 160. Unless otherwise stated herein, each of the components of improved rodent trap 100 are preferably comprised of a transparent or translucent materials, such as plastic, acrylic, or the like, to enable a user (not shown) to peer into the improved rodent trap 100 of the present invention to determine if a rodent 200 is present without opening the same and risking the premature release of the rodent 200.

As best shown in FIG. 1, enclosure portion 110 is preferably generally rectangular in shape and is comprised of a bottom 112, a front panel 114, a back panel 116, opposing side panels 118 that, along with removable lid portion 140 when properly attached to enclosure portion 110, form an interior space 119. More specifically, each of opposing side portions 118 are spaced apart from each other in generally parallel fashion, and extend from front panel 114 to back panel 116 and from bottom 112 to removable lid portion 140 when the same is properly attached to enclosure portion 110. Bottom 112, front panel 114, back panel 116, and opposing side panels 118 are preferably fixedly attached to one another, though it is also contemplated that they may also be removably attached to one another, for example, by fasteners (not shown). Additionally, front panel 114 further comprises an opening 1140 formed therein that corresponds to the size and shape of tunnel 130, as described more fully below.

The overall dimensions of improved rodent trap 100 are approximately six inches wide (as measured between opposing side panels 118) by approximately eleven inches long (as measured between front panel 114 and back panel 116) by three inches high (as measured from base or bottom 112 to the top of removable lid portion 140), and the various components are sized accordingly. Notwithstanding the forgoing, the improved rodent trap 100 of the present invention can by any suitable size, shape, and configuration as is known in the art without affecting the overall concept of the invention, provided that it accomplishes the above stated objectives. One of ordinary skill in the art will appreciate that the shape and size of the rodent trap 100 and its various components, as shown in the FIGS. are for illustrative purposes only, and that many other shapes and sizes of the rodent trap 100 are well within the scope of the present disclosure. Although dimensions of the rodent trap 100 and its components (i.e., length, width, and height) are important design parameters for good performance, the rodent trap 100 and its various components may be any shape or size that ensures optimal performance during use and/or that suits user need and/or preference.

The inboard side of each of opposing side panels 118 further comprise a generally F-shaped channel 1180 positioned near the top end (the top end being opposite of the portion of side panel 118 attached to bottom 112 and adjacent to removable lid portion 140) of side panel 118, and that preferably extends the entire length of the opposing side panel 118, as measured from the front panel 114 to the back panel 116. Similarly, the inboard side of front panel 114 further comprises a corresponding generally F-shaped channel 1180 positioned near the top end (the top end being opposite of the portion of front panel 114 attached to bottom 112 and adjacent to removable lid portion 140) of front panel 114, and that preferably extends the entire length of the front panel 114, as measured between opposing side panels 118. As used herein, the term inboard refers to the portion of the panel 118, 114 that faces the interior space 119 of the enclosure 110, and the term outboard refers to the opposite side of the respective panel (and that faces away from the interior space 119 of the enclosure 110).

As best shown in FIG. 5, “F” shaped channel 1180 is further comprised of a pair of spaced apart legs 1182 with an opening or slot 1184 formed therebetween, wherein said pair of spaced apart legs 1182 extend outwardly from the inboard face of each of front panel 114 and opposing side panels 118 in the direction of the interior space 119 of the enclosure 110. As explained more fully below, opening or slot 1184 is useful for slidably receiving removable lid portion 140 and retaining the same therein. Accordingly, the thickness of slot 1184 is sized slightly bigger than the overall thickness of the removable lid portion 140 which is preferably approximately ⅛^{th} of an inch.

As best shown in FIGS. 1 through 3, tunnel 130 is in fluid communication with opening 1140 in front panel 114 and is preferably comprised of a pair of opposing side panels 132 and a top panel 136 fixedly attached to each of the side panels 132. More specifically, each of side panels 132 extend upwardly from bottom 112 in a generally spaced apart and parallel fashion and are connected to one another by top panel 136. The overall size and shape of tunnel 130 is designed to permit a rodent to pass therethrough, and is preferably approximately two inches in length as measured from front panel 114 in the direction of the interior space 119, approximately 1.25 inches in width, as measured between opposing side panels 132, and approximately 1.25 inches in height as measured from bottom 112 to top panel 136. Nonetheless, it is contemplated that other dimensions, shaped and configuration could also be used.

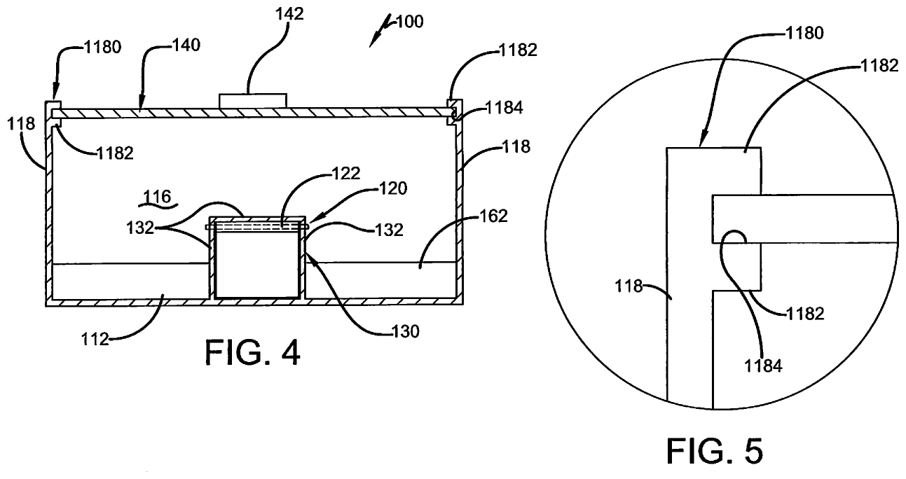

As explained more fully below, trap door mechanism 120 is positioned partway along the length of tunnel 130 and, more specifically, approximately ¾″ from the front panel 114. The presence of trap door mechanism 120 serves to bifurcate tunnel 130 into an exterior portion 137 and an interior portion 138, wherein the exterior portion 137 is the portion closest to front panel 114. As best shown in FIGS. 2 through 4, trap door mechanism 120 is preferably comprised of a movable door 122 and a spring hinge 124, and is positioned partway along the length of tunnel 130, as described above. More specifically, spring hinge 124 is fixedly attached to the underside of top panel 136, and movable door 122 is attached to spring hinge 124. Further, movable door 122 is sized just slightly smaller than the interior dimensions of tunnel 130 to permit it to rotate about spring hinge 124. Spring hinge 124 of trap door mechanism 120 is positioned and tensioned such that in its natural, resting position, movable door 122 substantially blocks tunnel 130. Further, from said resting position, movable door 122 is only rotatable inwardly in the direction of interior space 119 to permit a rodent 200 to enter the improved rodent trap 100. However, once a rodent 200 passes through the trap door mechanism 120, and the door 122 returns to its natural resting position (i.e., substantially blocking tunnel 130), the rodent 200 is not able to pass back through the movable door 122 in the direction of exterior portion 137.

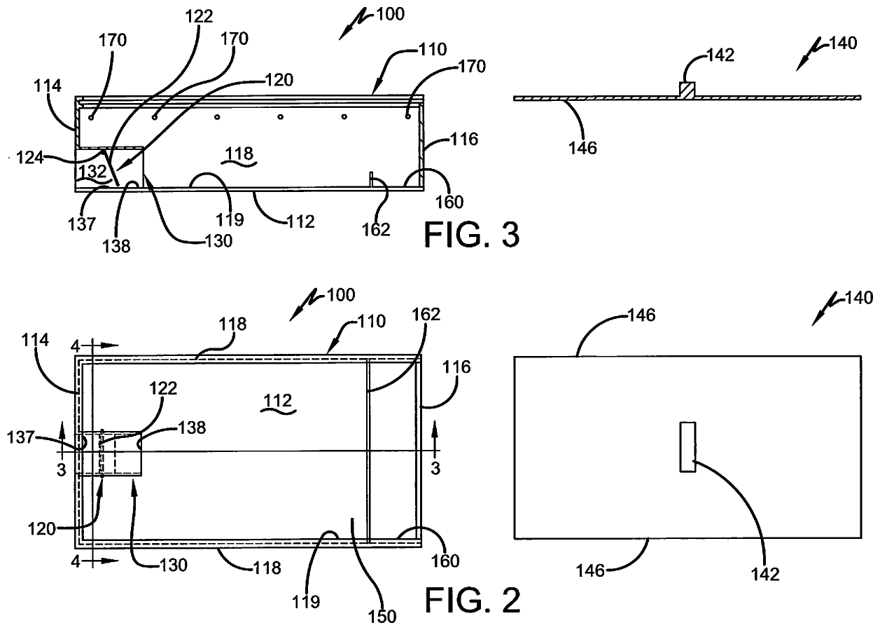

As best shown in FIGS. 2 and 3, removable lid 140 is generally rectangular in shape and sized to be slidably and matingly engaged with the “F” shaped channel 1180 of opposing sides 118 and front panel 114 from the rear of the device (i.e., near the back panel 116). More specifically, the side edges 146 of removable lid 140 are positioned within the slot 1184 of “F” channel 1180 of opposing sides 118 and slid in the direction of front panel 114. Accordingly, the overall height of back panel 116 is slightly smaller than the height of front panels 114 and opposing side panels 118, but still tall enough to meet the underside of removable lid 140 so as to eliminate any gap or space therebetween through which a rodent 200 may escape. Removable lid portion 140 may further comprise one or more handles 142 for convenient handling of the improved rodent trap 100 of the present invention.

As noted above, the improved rodent trap 100 of the present invention may further comprise a food tray 150 for storing food that can sustain the rodent 200 during its period of captivity. Bottom 114 may serve as food tray 150, or it may be a separate standalone device (not shown) that is removably or fixedly attached to bottom 114 or one or both of opposing side walls 118.

Similarly, improved rodent trap 100 of the present invention may further comprise a water basin 160 for storing and providing water to a captured rodent 200, thereby sustaining it during its period of captivity. In a preferred embodiment of the present invention, water basin 160 is preferably located near the rear or back portion of the enclosure 110 so as to not impede a rodent's pathway into the interior space 119 of the enclosure 110 via tunnel 130 and trap door mechanism. More specifically, water basin 160 is formed by bottom 112, opposing side panels 118, back panel 116 and a water basin panel 162 that extends between opposing side panels 118 in a generally spaced apart and parallel relationship to back panel 116. Initial experimental data has shown that a height of water basin panel 162 of approximately ½″ will provide enough volume of water to sustain a captured rodent 200 for a period of several days. Nonetheless, it is contemplated that other heights and configurations could also be used, as long as they provide adequate access to water for the captured rodent.

In a preferred embodiment of the present invention, one or more of each of front panel 114, back panel 116, opposing side panels 118 and removable lid portion 140 further comprise one or more continuous openings 170 therein that act as air holes and that permit fresh air to flow into and out of interior space 119 of enclosure 112 for the benefit of rodents 200 contained therein. Openings 170 are preferably ⅛^{th} of an inch in diameter to permit adequate air flow, but that are small enough to prevent the captured rodents 200 from escaping from the improved rodent trap 100 of the present invention.

Additionally, the generally transparent or translucent nature of the improved rodent trap 100 of the present invention and its various components allow a user to easily see if a rodent in present in the rodent trap 100 upon returning to collect the same and without having to remove the removable lid portion and risk the captured rodent escaping into the various space in which it was captured. Likewise, if a rodent 200 is present in the rodent trap 100, the user (not shown) may use handle 140 to easily transport the improved rodent trap 100 to an appropriate location to release the rodent into the wild and may do so by slidably removing the removable lid 140 from the “F” channel 1180 to access the interior space 119.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rodent trap comprising:
an enclosure;
a lid removably attached to the enclosure;
a tunnel; and
a trap door mechanism positioned within said tunnel.

2. The rodent trap of claim 1 further comprising a food tray and a water basin, wherein the water basin is fixedly attached to the enclosure.

3. The rodent trap of claim 1, wherein at least one of the enclosure and the lid are comprised of a transparent material.

4. The rodent trap of claim 1, wherein the enclosure is formed by a bottom panel, opposing side panels, a front panel and a back panel.

5. The rodent trap of claim 4, wherein the opposing side panels further comprise a “F” shaped channel for receipt of the lid.

6. The rodent trap of claim 4, wherein at least one of the lid, the opposing side panels, the front panel and the back panel further comprise at least one continuous opening therein to permit air to enter into the enclosure.

7. The rodent trap of claim 1, wherein the trap door mechanism further comprises a repositionable door and a spring.

8. The rodent trap of claim 1, wherein at least one of the enclosure and the lid are comprised of a translucent material.

9. A rodent trap comprising:
an enclosure having a pair of opposing “F” shaped channels;
a lid removably positioned in the pair of opposing “F” shaped channels;
a tunnel; and
a trap door mechanism.

10. The rodent trap of claim 9 further comprising a food tray and a water basin, wherein the water basin is fixedly attached to the enclosure.

11. The rodent trap of claim 9, wherein at least one of the enclosure and the lid are comprised of a transparent material.

12. The rodent trap of claim 9, wherein the enclosure is formed by a bottom panel, opposing side panels, a front panel and a back panel.

13. The rodent trap of claim 12, wherein the each of the opposing “F” shaped channels are positioned on one of said opposing side panels.

14. The rodent trap of claim 12, wherein at least one of the lid, the opposing side panels, the front panel and the back panel further comprise at least one continuous opening therein to permit air to enter into the enclosure.

15. The rodent trap of claim 9, wherein the trap door mechanism further comprises a repositionable door and a spring.

16. The rodent trap of claim 9, wherein at least one of the enclosure and the lid are comprised of a translucent material.

17. The rodent trap of claim 9, wherein the lid further comprises a handle.

18. A rodent trap comprising:
an enclosure formed by a front panel, a back panel, a bottom and a pair of opposing side panels;
a lid removably attached to the enclosure;
a tunnel;
a trap door mechanism; and
a water basin.

19. The rodent trap of claim 18, wherein the each of the pair of opposing side panels and the front panel further comprise a “F” shaped channel, and further wherein each of the “F” shaped channels are in fluid communication with one another.

20. The rodent trap of claim 18, wherein the front panel has continuous opening formed therein for receipt of the tunnel, and further wherein at least one of the enclosure and the lid are comprised of a transparent or translucent material.
